(19) United States
(12) Patent Application Publication
(10) Pub. No.: US 2011/0113456 A1
(43) Pub. Date: May 12, 2011

(54) METHOD FOR PROVIDING DIGITAL BROADCASTING SERVICE AND STREAMING SERVICE IN A PORTABLE TERMINAL

(75) Inventors: Dong-Hwan JI, Busan (KR); Jeong-Wook SEO, Daegu (KR); Bryan KIM, Daegu (KR); Eun-Jung SEO, Gumi-si (KR)

(73) Assignee: Samsung Electronics Co. Ltd., Suwon-si (KR)

(21) Appl. No.: 12/945,107

(22) Filed: Nov. 12, 2010

(30) Foreign Application Priority Data
Nov. 12, 2009 (KR) 10-2009-0109271

(51) Int. Cl. H04N 7/173

(52) U.S. Cl. 725/90

(57) ABSTRACT

A method for providing a digital broadcasting service and a streaming service in a portable terminal is provided. The method include receiving a request for moving a play position of broadcast content provided via the digital broadcasting service, determining whether streaming content corresponding to the broadcast content is available, the streaming content being provided in the streaming service, and playing the streaming content from the moved play position in a streaming fashion.

### PRIORITY

This application claims the benefit under 35 U.S.C. §119(a) of a Korean patent application filed in the Korean Intellectual Property Office on Nov. 12, 2009 and assigned Serial No. 10-2009-00109271, the entire disclosure of which is hereby incorporated by reference.

### BACKGROUND OF THE INVENTION

1. Field of the Invention

The present invention relates to a portable terminal. More particularly, the present invention relates to a method for providing a digital broadcasting service and a streaming service in a portable terminal.

2. Description of the Related Art

Owing to the development of mobile communication technology, portable terminals have been used for various purposes beyond the traditional voice call service. Hence, viewing digital broadcasting such as Digital Multimedia Broadcasting (DMB) or Digital Video Broadcasting-Handheld (DVB-H) through a portable terminal is now popular. In addition, a streaming service is also widespread, which enables download and reproduction of video clips, broadcast content, and media content over a broadband network such as a 3^{rd} Generation (3G) mobile communication network.

Despite the advantages of low price and ease of use, digital broadcasting has a drawback in that on-going broadcast content cannot be played from a specific position. On the other hand, the streaming service allows a user to readily download desired streaming content from a streaming server and to play the streaming content at a desired play position easily. However, the streaming service is generally more expensive than digital broadcasting. Accordingly, there is a need for developing a method for enabling a user to conveniently use a digital broadcasting service and a streaming service by taking their advantages and overcoming their shortcomings.

### SUMMARY OF THE INVENTION

An aspect of the present invention is to address at least the above-mentioned problems and/or disadvantages and to provide at least the advantages described below. Accordingly, an aspect of the present invention is to provide a method for using a digital broadcasting service and a streaming service conveniently at a low price.

In accordance with an aspect of the present invention, a method for providing a digital broadcasting service and a streaming service in a portable terminal is provided. The method includes receiving a request for moving a play position of broadcast contents being provided in the digital broadcasting service, determining whether streaming content corresponding to the broadcast content is available, the streaming contents being provided via the streaming service, and playing the streaming content from the moved play position in a streaming fashion.

In accordance with another aspect of the present invention, a portable terminal is provided. The portable terminal includes a display unit for displaying broadcast content provided from a broadcast service and streaming content provided from a streaming service, and a controller for determining whether streaming content corresponding to displayed broadcast content is available when a user requests to change a play position of the displayed broadcast content, and for controlling the display unit to display the corresponding streaming content from the requested play position.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram of a portable terminal according to an exemplary embodiment of the present invention;

FIG. 2 is a flowchart illustrating an operation for providing a digital broadcasting service and a streaming service in the portable terminal according to an exemplary embodiment of the present invention;

FIGS. 3A and 3B illustrate an example of the operation for providing a digital broadcasting service and a streaming service in the portable terminal according to an exemplary embodiment of the present invention; and

FIGS. 4A and 4B illustrate another example of the operation for providing a digital broadcasting service and a streaming service in the portable terminal according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term ‘broadcast content’ as used herein refers to content received from a broadcast server in a digital broadcasting service. The term ‘streaming content’ as used herein refers to content received from a streaming server in a streaming service.

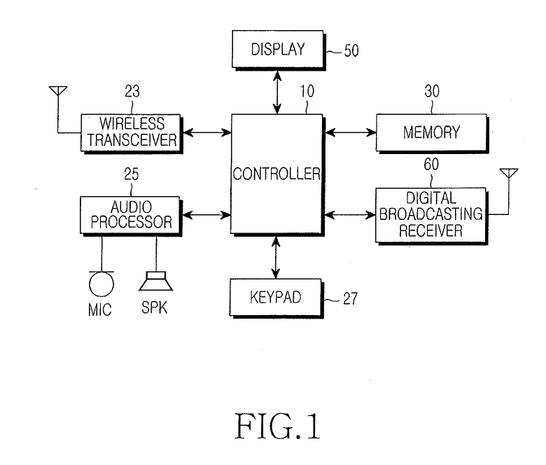

FIG. 1 is a block diagram of a portable terminal according to an exemplary embodiment of the present invention.

Referring to FIG. 1, a keypad 27 includes alpha-numerical keys for entering numbers and characters and function keys for setting functions. A wireless transceiver 23 performs a wireless communication function of the portable terminal and includes a Radio Frequency (RF) module and a modem. The RF module has an RF transmitter for upconverting the frequency of a transmission signal and amplifying the upconverted transmission signal, and an RF receiver for low-noise-amplifying a received signal and downconverting the frequency of the low-noise-amplified signal. The modem has a transmitter for encoding and modulating a transmission signal and a receiver for demodulating and decoding a signal received from the RF module. According to an exemplary embodiment of the present invention, the wireless transceiver 23 may establish a communication channel with a streaming server (not shown) under the control of a controller 10 and then may stream (e.g., receive) streaming content from the streaming server.

An audio processor 25 may include a variety of codecs. The codecs may include a data codec and an audio codec. The data codec processes packet data and the audio codec processes voice and an audio signal such as a multimedia file. The audio processor 25 reproduces a digital audio signal received from the modem by converting the digital audio signal into an audio analog signal through the audio codec, or transmits an analog audio signal generated from a microphone MIC to the modem after converting the analog audio signal into a digital audio signal. The codecs may be configured separately or incorporated into the controller 10 in the portable terminal.

A memory 30 includes a Read Only Memory (ROM) and a Random Access Memory (RAM). The memory 30 may include a program memory and a data memory, for storing programs to control the operations of the portable terminal and for storing booting data.

A display 50 displays a video signal and user data or call-related data. The display 50 may be a Liquid Crystal Display (LCD), an Organic Light Emitting Diode (OLED) display, or an Active Matrix (AM) OLED display. If the LCD, OLED display, or AMOLED display is configured as a touch screen, the display 50 may serve as an input unit along with the keypad 27, to control the portable terminal. In an exemplary embodiment of the present invention, therefore, the display 50 may be configured to include a touch screen so that the display 50 operates as an input unit for controlling the portable terminal, along with the keypad 27.

A digital broadcasting receiver 60 receives broadcast frames corresponding to broadcast content of digital broadcasting (e.g., DMB or DVB-H) and demodulates the broadcast frames under the control of the controller 10. In addition, the digital broadcasting receiver 60 includes a demodulator (not shown) for demodulating the received broadcast frames to DMB broadcast streams.

The controller 10 provides overall control to the portable terminal. The controller 10 includes a multimedia unit. The multimedia unit controls reception of a digital broadcast signal on a broadcast channel (e.g., a digital broadcast signal of broadcast content) selected by a user through channel frequency setting. The demodulator of the digital broadcasting receiver 60 demultiplexes a broadcast stream into an audio data stream and a video data stream, and the multimedia unit decodes the audio data stream and the video data stream respectively to an analog audio signal and an analog video signal.

The controller 10 may decode a demodulated broadcast stream of specific broadcast content received from the digital broadcasting receiver 60 and then output the decoded broadcast stream to the audio processor 25 and the display 50 through an audio signal processor (not shown) and a video signal processor (not shown).

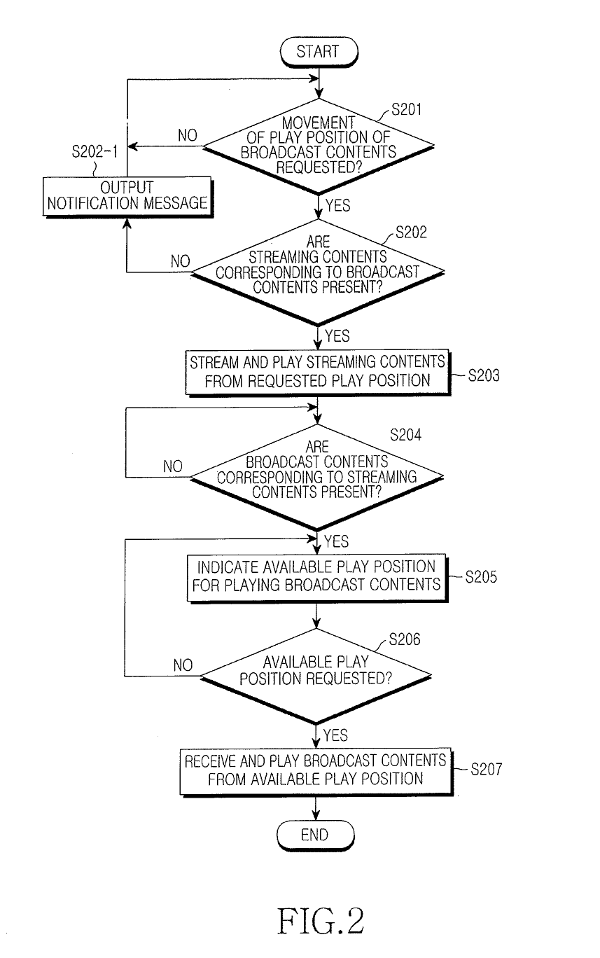

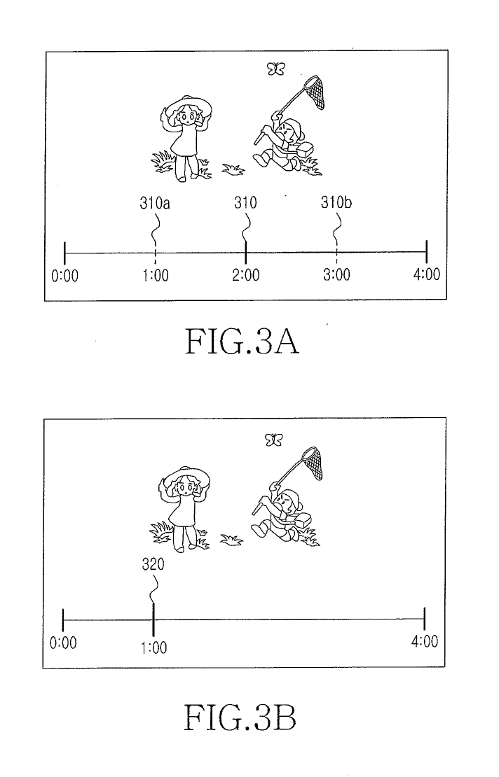

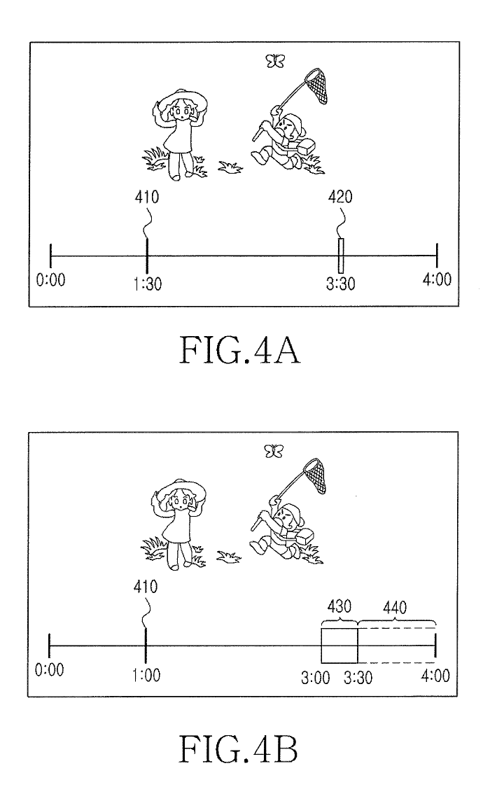

FIG. 2 is a flowchart illustrating an operation for providing a digital broadcasting service and a streaming service in the portable terminal according to an exemplary embodiment of the present invention, FIGS. 3A and 3B illustrate an example of the operation for providing a digital broadcasting service and a streaming service in the portable terminal according to an exemplary embodiment of the present invention, and FIGS. 4A and 4B illustrate another example of the operation for providing a digital broadcasting service and a streaming service in the portable terminal according to an exemplary embodiment of the present invention.

Referring to FIG. 2, upon receipt of a request for moving a play position for broadcast content being received in a digital broadcasting service in step S201, the controller 10 determines whether streaming content corresponding to the broadcast content is available in step S202. When the streaming content is available, the controller 10 controls streaming play of the streaming content from a requested play position in step S203.

Because broadcast content provided in the digital broadcasting service cannot be played (e.g., received) from a changed play position, even though the user requests moving the play position of the broadcast content, the controller 10 cannot accept the user's request in the digital broadcasting service. Accordingly, the controller 10 determines whether streaming content corresponding to the broadcast contents that the user requests to be played from a changed position (e.g., the streaming contents identical to the broadcast contents) is available in the streaming service.

When the streaming content corresponding to the broadcast content is available, the controller 10 discontinues reception of the broadcast content from a broadcasting server that provides the digital broadcasting service and instead controls streaming play of the streaming content from a streaming server (not shown) that provides the streaming service, from the requested play position. Hence, the controller 10 can overcome the conventional digital broadcasting service's inability to play content from a changed position.

The controller 10 may determine whether the streaming content corresponding to the broadcast content is available by checking related information that is included in an Electronic Program Guide (EPG) or in a specified field (e.g., a reserved field) of EPG-like digital broadcast information, or received from a broadcasting service provider, a mobile communication service provider, or a Content Provider (CP). The related information may be information indicating the availability of the streaming content or information about a link to the streaming content.

Referring to FIG. 3A, while viewing broadcast content (e.g., an animation) from a play position 310 in a digital broadcasting service, the user may request play of the broadcast content from a changed play position 310a or 310b, for example by a key input or a touch input. The controller 10 determines whether streaming content corresponding to the broadcast content is available in response to the user's request. When the streaming content is available, the controller 10 controls streaming play of the streaming content from a requested play position 320 from the streaming server through the display 50 and the audio processor 25, as illustrated in FIG. 3B. When the streaming content is not available, the controller 10 controls output of a notification message (e.g., visual information, audible information, or vibrations) indicating that play of the broadcast content from the requested play position is not available to the user in step S202-1.

Referring to FIG. 2 again, the controller 10 determines whether broadcast content corresponding to the streaming content provided in the streaming service is available in step S204. In step S205, the controller 10 indicates an available play position of the broadcast content out of the whole play time period of the streaming content. Upon receipt of a request for the indicated play position from the user in step S206, the controller 10 controls broadcast content to be received and played from the requested play position in step S207.

According to an exemplary embodiment of the present invention, the controller 10 can determine broadcast content (serviced in the digital broadcasting service) corresponding to streaming content is available, while playing the streaming content in a streaming fashion. The controller 10 may determine the presence or absence of the broadcast contents corresponding to the streaming content without solicitation from the user. The determination may be made by referring to related information that is included in a specific header of the streaming content or received from a broadcast service provider, a mobile communication service provider, CP, or other source.

When determining the availability of the broadcast content corresponding to the streaming content, the controller 10 controls notification of a play position from which the broadcast content can be played out of the whole play time period of the streaming content. Upon receipt of a request for moving to the play position from the user, the controller 10 discontinues streaming of the streaming content and instead controls the broadcast content to be received and played from the broadcasting server (not shown) that provides the digital broadcasting service from the notified play position.

In this manner, the controller 10 can provide the user with broadcast content that is relatively cheap, instead of the more expensive streaming content. For the same content (the identical streaming content and broadcast content), the user can select the broadcast content, thus saving cost.

Referring to FIG. 4A, while the user is viewing streaming content from a play position 410 in the streaming service, the controller 10 determines whether broadcast content corresponding to the streaming content is available. When the broadcast content is available, the controller 10 notifies the user that the broadcast content is available to the user from a play position 420 in the digital broadcasting service, for example, that the broadcast content is now played from the play position 420.

If the user requests to move to the play position 420, for example, by a key input or a touch input, the controller 10 discontinues streaming of the streaming content from the streaming server and controls the broadcast content to be received from the broadcasting server that provides the digital broadcasting service and played from the play position 420.

FIG. 4B illustrates a modification to the exemplary embodiment illustrated in FIG. 4A. According to an exemplary embodiment of the present invention illustrated in FIG. 4B, broadcast content is pre-stored. When determining the availability of the broadcast content corresponding to the streaming content, the controller 10 preliminarily receives and stores the broadcast content for a predetermined play time (e.g., 30 seconds from 3:00 to 3:30) and indicates the time period as denoted by reference numeral 430. Upon receipt of a request for moving to the play position 430 from the user, the controller 10 controls play of the pre-stored broadcast content from the requested play position 430. For example, when the user requests movement from the play position 410 to the middle (3:15) of the time period 430 by a key input or a touch input, the controller 10 controls play of the pre-stored broadcast content from the time 3:15. The controller 10 may receive the remaining part of the broadcast content as denoted by reference numeral 440 and store the remaining broadcast content 440, so as to play the remaining broadcast content 440 when needed.

As is apparent from the above description of exemplary embodiments of the present invention, a relatively expensive streaming service can be efficiently used, while overcoming the shortcoming of the conventional digital broadcasting service that a play position cannot be moved.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for providing a digital broadcasting service and a streaming service in a portable terminal, comprising:
receiving a request for moving a play position of broadcast content provided via the digital broadcasting service;
determining whether streaming content corresponding to the broadcast content is available, the streaming content being provided via the streaming service; and
playing the streaming content from the moved play position in a streaming fashion.

2. The method of claim 1, further comprising:
determining whether broadcast content corresponding to the played streaming content is available; and
indicating an available play position for playing the broadcast content corresponding to the played streaming content out of a whole play time period of the played streaming content, when the broadcast content corresponding to the played streaming content is available.

3. The method of claim 2, further comprising:
receiving the broadcast content corresponding to the played streaming content from a broadcasting server and playing the broadcast content corresponding to the played streaming content from the available play position, upon receipt of a request for moving to the available play position.

4. The method of claim 1, further comprising:
determining whether broadcast content corresponding to the played streaming content is available; and
receiving and pre-storing the broadcast content corresponding to the played streaming content for a predetermined play time period, when the broadcast content corresponding to the played streaming content is available.

5. The method of claim 4, further comprising indicating a whole play time period of the played streaming content and the predetermined play time period.

6. The method of claim 5, further comprising playing the pre-stored broadcast content, starting from the predetermined play time period, upon receipt of a request for moving a play position to the predetermined play time period.

7. A portable terminal, comprising:
a display unit for displaying broadcast content provided from a broadcast service and streaming content provided from a streaming service; and
a controller for determining whether streaming content corresponding to displayed broadcast content is available when a user requests to change a play position of the displayed broadcast content, and for controlling the display unit to display the corresponding streaming content from the requested play position.

8. The portable terminal of claim 7, wherein, when the controller determines that broadcast content corresponding to currently displayed streaming content is available, the controller controls the display to display an indication that the corresponding broadcast content is available and a play position from which the corresponding broadcast content may be played.

9. The portable terminal of claim 8, wherein the controller controls the display unit to display the corresponding broadcast content upon receipt of a request to play the corresponding broadcast content.

10. The portable terminal of claim 7, further comprising:
a storage unit,
wherein, when the controller determines that broadcast content corresponding to displayed streaming content is available, the controller stores at least a portion of corresponding broadcast content in the storage unit.

11. The portable terminal of claim 10, wherein the controller controls the display unit to display a period of time corresponding to the stored portion of the corresponding broadcast content.
